(19) United States
(12) Patent Application Publication
(10) Pub. No.: US 2010/0060424 A1
(43) Pub. Date: Mar. 11, 2010

(54) Range Extension and Multiple Access in Modulated Backscatter Systems

(75) Inventors: Ben J. Wild, Sunnyvale, CA (US); Upamanyu Madhow, Santa Barbara, CA (US); Kannan Ramchandran, El Cerrito, CA (US); Artem Tkachenko, Fremont, CA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Checkpoint Systems, Inc., Thorofare, NJ (US)

(21) Appl. No.: 12/406,629

(22) Filed: Mar. 18, 2009

Related U.S. Application Data
(60) Provisional application No. 61/069,812, filed on Mar. 19, 2008.

(51) Int. Cl. H04Q 5/22; H04B 1/707; H04B 7/216

(52) U.S. Cl. 340/10.1; 375/141; 375/E01.002; 370/342

(57) ABSTRACT

One or more readers transmit radio frequency (RF) beacons to be electronically reflected by tags. Data transmitted via modulated backscatter from radio frequency identification (RFID) tags is encoded so as to permit reliable demodulation of simultaneous transmissions from multiple tags. This includes the use of spreading sequences as in direct sequence spread spectrum, where the spreading sequences may be a function of the tag ID, or may be randomly chosen. Backscattered signals from multiple tags may be detected using well-known receiver techniques for code division multiple access (CDMA) systems. Readers may be equipped with transmit and/or receive antenna arrays. A receive antenna array permits a reader to estimate directions of arrival for received signals, as well as to enhance range by performing receive beamforming.

### CROSS-REFERENCE TO RELATED APPLICATIONS

This utility application claims the benefit under 35 U.S.C. §119(e) of Provisional Application Ser. No. 61/069,812, filed on Mar. 19, 2008, entitled RANGE EXTENSION AND MULTIPLE ACCESS IN MODULATED BACKSCATTER SYSTEMS and whose entire disclosure is incorporated by reference herein.

### BACKGROUND OF THE INVENTION

1. Field of Invention

The current invention relates generally to systems, and more particularly to RFID systems employing modulated backscatter for ease of illustration.

2. Description of Related Art

In RFID systems employing modulated backscatter, a reader transmits a radio frequency (RF) signal, which is electronically reflected by tags. Batteryless or passive tags draw the energy required to run their circuitry from the received RF signal from the reader, while battery-assisted or semi-passive tags employ a battery to energize their circuitry. For passive tags, where the tag is powered up by the signal emitted by the reader, the downlink from reader to tag is typically the bottleneck in the link budget, because of the received power threshold required to power up the tag. By using a battery to provide power to the tag's circuitry, semi-passive tags relieve this downlink bottleneck, thus producing a significant increase in range. A modulated backscatter system may employ either passive or semi-passive tags, or a combination thereof. In either case, in a modulated backscatter based RFID system, the tags electronically reflect the signal received from the reader, while putting data modulation on top of the reflected signal. In addition, they may shift the frequency of the signal being reflected, in order to separate the modulated backscatter from unmodulated reflections of the reader's signal from other scatterers.

Most existing RFID communication protocols only support one tag communicating with the reader at a time. Simultaneous transmissions from multiple tags within communication range of a reader typically lead to collisions, which must be resolved using collision resolution or multiple access algorithms whose objective is to ensure that tags ultimately transmit one at a time to the reader. An example of a collision resolution system is included in the commonly assigned U.S. Pat. No. 7,079,259, entitled “Anticollision Protocol with Fast Read Request and Additional Schemes for Reading Multiple Transponders in an RFID System.”

The range for RFID systems using passive tags is typically determined by the “downlink” from reader to tag, which is responsible for energizing the tag. However, for passive tags which can store either RF energy or energy gathered from other sources, the downlink signal from the reader may not be the only source for powering the tag during reader-tag communication. In this case, the bottleneck may become the uplink, whose link budget must account for the round-trip propagation loss from reader to tag and back. In free space, this loss is proportional to 1/R⁴, where R denotes the range. Similarly, for semi-passive tags, the uplink can become the bottleneck, since the downlink link budget only needs to be such that the tag circuitry can detect the reader's signal, and does not need to power the tag.

All references cited herein are incorporated herein by reference in their entireties.

### BRIEF SUMMARY OF THE INVENTION

One or more readers transmit radio frequency (RF) beacons to be electronically reflected by tags. Data transmitted via modulated backscatter from radio frequency identification (RFID) tags is encoded so as to permit reliable demodulation of simultaneous transmissions from multiple tags. This includes the use of spreading sequences as in direct sequence spread spectrum, where the spreading sequences may be a function of the tag ID, or may be randomly chosen. Backscattered signals from multiple tags may be detected using well-known receiver techniques for code division multiple access (CDMA) systems. Readers may be equipped with transmit and/or receive antenna arrays. A transmit antenna array permits a reader to direct RF energy towards a region of interest using transmit beamforming, thus increasing range, as well as providing location information for tags that respond to the reader. A receive antenna array permits a reader to estimate directions of arrival for received signals, as well as to enhance range by performing receive beamforming.

In accordance with an example of the preferred embodiment, the invention includes an RFID communication system. The system includes an RFID reader in communication with a plurality of RFID tags having an integrated circuit and a memory unit. The memory unit stores tag data representing the RFID tag identification. Each RFID tag has a spreading sequence associated with the tag. The RFID tags respond to an RF signal from the RFID reader with a spread spectrum modulated backscatter signal including the tag data mixed with the spreading sequence. The RFID tag provides the spread spectrum modulated backscatter signal having a signal to noise ratio higher that a corresponding backscatter signal without the spreading sequence. The RFID reader receives and correlates the spread spectrum modulated backscatter signal against expected spreading sequences to identify the corresponding RFID tag at a distance greater than for an RFID tag sending the corresponding backscatter signal without the spreading sequence.

In accordance with another example of the preferred embodiment, the invention includes a method for RFID communication. The method includes the steps of transmitting an RF signal from a RFID reader to a RFID tag, mixing a RFID tag identification data with a spreading sequence to produce a resultant output, reflecting the RF signal from the RFID tag to the RFD reader as a spread spectrum modulated backscatter signal modulated with the resultant output and having a signal to noise ratio higher than a backscatter signal modulated without the spreading sequence, reading the spread spectrum modulated backscatter signal at the RFID reader, the RFID reader having a first receive antenna, and correlating the spread spectrum modulated backscatter signal against expected spreading sequences to identify the corresponding RFID tag that provided the spread spectrum modulated backscatter signal, even with the spread spectrum modulated backscatter signal being reflected at a power too low to be read by the RFID reader when absent the spreading sequence.

In accordance with yet another example of the preferred embodiments, the invention includes a CDMA communication system. The system includes an RFID reader in communication with a plurality of RFID tags having an integrated circuit and a memory unit. The memory unit stores tag data representing the RFID tag identification. Each RFID tag has a spreading sequence associated with the tag. The RFID tags responds to an RF signal from the RFID reader with a CDMA signal including the tag data mixed with the spreading sequence. The RFID tag provides the CDMA signal having a signal to noise ratio higher that a corresponding backscatter signal without the spreading sequence. The RFID reader receives and correlates the CDMA signal against expected spreading sequences to identify the corresponding RFID tag at a distance greater than for an RFID tag sending the corresponding backscatter signal without the spreading sequence.

### BRIEF DESCRIPTION OF SEVERAL VIEWS OF THE DRAWINGS

The invention will be described in conjunction with the following drawings in which like reference numerals designate like elements and wherein:

FIG. 1 is an exemplary view of an RFID system in accordance with the preferred embodiments of the invention;

FIG. 2 is a schematic of an exemplary modulation procedure provided by the preferred RFID tags;

FIG. 3 is schematic of exemplary signals transmitted by a RFID reader for determining range in accordance with the preferred embodiments; and

FIG. 4 is a diagram illustrating a RFID tag listening to multiple readers at different frequencies.

### DETAILED DESCRIPTION OF THE INVENTION

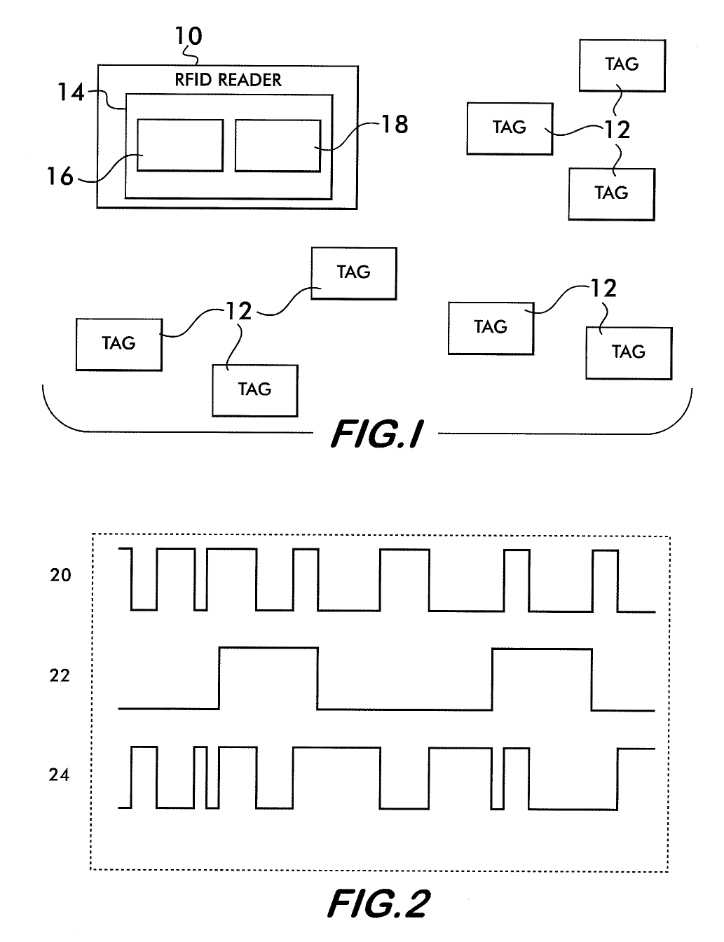

FIG. 1 depicts an example of the preferred embodiments, with an RFID reader 10 in communication with a plurality of RFID tags 12. While not being limited to a particular theory, the tags 12 include an integrated circuit (IC) 14 having a memory unit 16 and preferably a processor 18. The memory unit 16 stores data representing the tag's identification, biographical information and, if desired, the tag's spreading sequence information. The processor 18 may be used to generate the tags' spreading sequence as needed for producing a spread spectrum modulated backscatter signal as discussed in greater detail below.

The reader broadcasts an RF beacon, which tags respond to with modulated backscatter. Tags can respond to the RF beacon asynchronously at randomly chosen times, at times determined by a deterministic rules implemented within the tag, at times explicitly specified by the reader in the beacon, or at times that bear a fixed or randomly chosen relationship with markers in the reader's beacon. The symbol sequence sent by a tag is preferably chosen to have good autocorrelation properties, i.e., to have small normalized correlation with shifts of itself. Symbol sequences sent by different tags may be chosen to have good cross-correlation properties, i.e., to have small normalized correlation with each other.

The tag identification number is encoded in the symbol sequence in a number of ways. The symbol sequence is preferably a direct sequence spread spectrum waveform, in which a chip sequence or spreading sequence, with good autocorrelation and cross-correlation properties is modulated at a slower rate by a data sequence which carries information. For example, the low frequency data stored in each tag is multiplied by a high frequency pseudo-random spreading sequence that is preferably unique to each tag. FIG. 2 depicts an exemplary modulation procedure provided by the tags 12. An exemplary spreading sequence 20 is mixed (e.g., multiplied) with the tags data 22 to produce a resulting high frequency waveform 24 of the tag's data modulated by their spreading sequence.

With knowledge of the spreading sequence on each tag, the reader can separate the desired data from the reflected signal by filtering out the spreading sequence. Therefore, the tag ID, as well as other information to be sent from tag to reader, may be encoded in the spreading sequence, in the data modulating the spreading sequence, or in a combination thereof.

The RFID tags may need to be modified for spread spectrum modulation depending on how the modulation is implemented. If the reader initiates the spread spectrum modification by sending the code sequence to the tags, then the tags will respond with a backscattered representation of the spread sequence modulated by the tags data. Alternatively, the tags ICs 14 are modified to produce their spreading sequence modulated with their data.

If the period of the spreading sequence coincides with the span of a data symbol, then it is termed a short spreading sequence. If the spreading sequence is aperiodic, or has a period significantly larger than the span of a data symbol, then it is termed a long spreading sequence. The number of symbols, or chips, corresponding to the span of a single data symbol, is termed the processing gain.

The reader may correlate the received signal against possible spreading sequences used by tags. Integration over the spreading sequence increases the signal-to-noise (s/n) ratio, and enhances the reliability of data demodulation. Thus, by choosing the processing gain to be long enough, it is possible to enhance the range of reliable communication between reader and tags. For example, a processing gain of 256 can, in principle, yield a four-fold increase in the range R, assuming 1/R⁴ propagation loss, and a sixteen-fold increase in range assuming 1/R² propagation loss.

The reader can read a tag at greater distance without the benefit of increased power from the receiver due to the increased s/n ratio provided by the longer spreading sequenced signal reflected by the tag. Moreover, since the receiver knows the code sequences to expect, the receiver can much more efficiently filter the tag's low power signal from the electromagnetic noise. In addition, with a spread bandwidth, interference issues inherent in a narrow bandwidth are relieved.

The use of spread spectrum may also permit multiple tags to communicate reliably with the reader at a given time, thus constituting a code division multiple access (CDMA) system. In this case, the reader is equipped with a receiver capable of decoding multiple tags, using standard CDMA reception techniques. One standard technique is to correlate against the spreading sequence of each tag being demodulated. The outputs of these correlators will have residual interference because of the cross-correlation between different spreading sequences. This interference is small for well-designed spreading sequences, and the system may provide adequate performance even when the receiver ignores the structure of the multiple-access interference due to multiple tags. However, it is also possible to use multiuser detection techniques that exploit the interference structure. These include linear decorrelation, interference cancellation, and maximum likelihood.

For short spreading sequences, the interference has a cyclostationary structure, which can be exploited by adaptive multiuser detection, or interference suppression techniques. These include linear minimum mean squared error (LMMSE) and decision feedback receivers, which can be adapted using algorithms such as least means squares (LMS), recursive least squares (RLS), or block least squares. If the receiver has multiple antenna arrays, then multiuser detection can be done using spatiotemporal processing (for example, by using LMMSE-based correlation for a block of samples for all antennas corresponding to a given time interval).

For a reader with multiple receive antennas, the received signal is correlated against the spreading sequence for each antenna. Once this despreading operation has been performed, the remainder of the processing can be as in a system without spreading. Techniques for location estimation using a receive antenna array can now be applied. Examples of such techniques are included in the recently filed patent application Ser. No. 12/072,423, with the same assignee, entitled, “Localizing Tagged Assets Using Modulated Backscatter”, which is hereby incorporated by reference in its entirety. Location estimation can further be enhanced by using received signal strength. When multiple tags communicate simultaneously with the reader, multiuser detection techniques may be used in conjunction with location estimation.

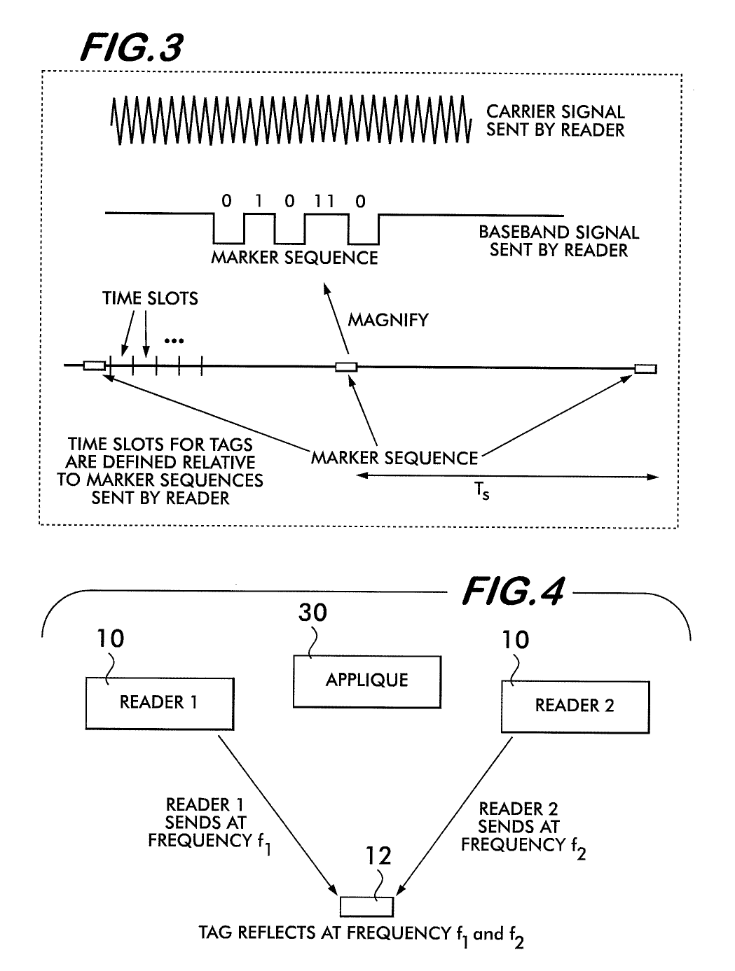

Location estimation can be further enhanced by providing explicitly for range estimation. FIG. 3 illustrates how transmitting at times relative to marker sequences allows estimation of round-trip time, and hence range. Time slots for tags 12 are defined relative to marker sequences sent by the reader 10. Multiple access can be facilitated by slotting the allowable transmission times, with the slot used encoded in the tag data. As can be seen in FIG. 3, the reader's RF beacon may contain marker sequences at regularly spaced intervals whose length Tₛ is chosen to be larger than the largest round-trip time of interest. For example, if the range of interest is at most 100 meters, then the round-trip time at the speed of light is 600 nanoseconds.

In this case, by setting Tₛ to be 1 millisecond, for example, we avoid ambiguity in the timing of the backscatter signal received from a tag. A tag may respond at a time which is in fixed relationship to a given marker. For example, it may respond immediately upon detection of a marker. In this case, the reader can estimate the round-trip time (RTT) between itself and the tag as the time between the last transmitted marker signal and the signal received from the tag.

In another example of the preferred embodiments, the tag may respond at a time t₀ after the marker signal, and may encode the time t₀ into its transmitted data in order to inform the reader of it. In this case, the reader may subtract the time offset t₀ from the RTT estimate described above, in order to obtain an accurate estimate of the RTT. Different tags may use different values oft₀, possibly chosen randomly, in order to enable more efficient multiple access. For example, the time offsets can be chosen as multiples of a time slot in which the tag's transmission fits, in order to implement a time division multiple access (TDMA) scheme. For uncoordinated transmissions among tags, it may still be the case that multiple tags transmit in a single time slot. In this case, reliable transmission may still be possible by virtue of the CDMA method described above.

Tags may operate on a low duty cycle, waking up periodically or intermittently to perform backscatter. If marker sequences are being employed as described previously, then a tag that wakes up may listen for a marker sequence, and then transmit its backscatter signal at a time related to the marker sequence as described above. For example, if a tag wakes up every second, and the spacing between marker sequences is 1 millisecond, then the maximum time that the tag has to wait after waking up in order to see a marker sequence is 1 millisecond. Assuming that the tag's transmission completes before the next marker sequence, the maximum amount of time the tag has to remain awake is 2 milliseconds. This results in a duty cycle of 1:500.

Multiple readers may be deployed in an area of interest. If multiple readers are simultaneously sending beacons on two different frequencies, a tag which can hear them both will reflect both signals, as shown in FIG. 4. For example, FIG. 4 depicts a tag 12 listening to multiple readers 10. The readers 10 transmit RF signals at different frequencies resulting in a reflected backscatter signal from the tag 12 at both frequencies, which can be processed by a network of readers 10 and appliqués 30. In particular, each reader 10 can process the signal reflected by the tag 12 in the frequency band that the reader is transmitting. It may also process the signal in other frequency bands, corresponding to the backscatter resulting from signals sent by other readers. Each reader 10 can derive its own location estimate for the tag, based on the methods discussed above. These location estimates can be aggregated to obtain an improved location estimate.

In addition to readers which transmit beacons, appliqué nodes that listen to communication between reader and tag to infer location information can also be employed. The use of such nodes is disclosed in the U.S. application Ser. No. 12/070,024, filed with the same assignee, entitled “Appliqué Nodes for Performance and Functionality Enhancement in Radio Frequency Identification Systems”, the disclosure of which is incorporated herein by reference in its entirety. The overall system may derive a location estimate for a given tag based on information gathered from multiple readers and appliqués, which may be networked together.

Tag multiple access can be accomplished using CDMA, TDMA or spatial division multiple access (SDMA), and combinations thereof. One mechanism for SDMA is for the reader to select an area from which tags should respond by transmit beamforming using an electronically steerable transmit antenna array, or a mechanically steered antenna. Another mechanism for SDMA is to use receive beamforming using an electronically steerable receive antenna array, or a mechanically steered antenna. A combination of CDMA and SDMA can be accomplished by using spatiotemporal processing at the receiver aimed to demodulating signals from multiple tags simultaneously. Approximate TDMA can be accomplished by different tags selecting different intervals for transmission, relative to the reader's marker signal, as depicted in FIG. 1. Multiple tags may still end up transmitting in the same time slot, but their transmissions can be resolved using CDMA or SDMA.

While the invention has been described in detail and with reference to specific examples thereof, it will be apparent to one skilled in the art that various changes and modifications can be made therein without departing from the spirit and scope thereof.

What is claimed is:

1. An RFID communication system comprising an RFID reader in communication with a plurality of RFID tags having an integrated circuit and a memory unit, the memory unit storing tag data representing the RFID tag identification, each RFID tag having a spreading sequence associated with the tag, the RFID tags responding to an RF signal from the RFID reader with a spread spectrum modulated backscatter signal including the tag data mixed with the spreading sequence, the RFID tag providing the spread spectrum modulated backscatter signal having a signal to noise ratio higher that a corresponding backscatter signal without the spreading sequence, the RFID reader receiving and correlating the spread spectrum modulated backscatter signal against expected spreading sequences to identify the corresponding RFID tag at a distance greater than for an RFID tag sending the corresponding backscatter signal without the spreading sequence.

2. The RFID communication system of claim 1, the RFID tags further comprising a processor that generates the spreading sequence of the respective tag.

3. The RFID communication system of claim 1, the RFID reader further comprising a processor that generates the spreading sequence of each RFID tag.

4. The RFID communication system of claim 1, wherein the RF signal and the spread spectrum modulated backscatter signal are CDMA signals.

5. The RFID communication system of claim 1, further comprising a second RFID reader that receives the spread spectrum modulated backscatter signal against expected spreading sequences to identify the corresponding RFID tag, the RFID communication system determining the position of the corresponding RFID tag based on the spread spectrum modulated backscatter signal received at both RFID readers.

6. The RFID communication system of claim 1, the RFID reader comprising a plurality of receive antennas that receives the spread spectrum modulated backscatter signal, the RFID communication system determining the position of the corresponding RFID tag based on the spread spectrum modulated backscatter signal received at the plurality of receive antennas.

7. A method for RFD communication, comprising:
transmitting an RF signal from an RFID reader to a RFID tag;
mixing a RFID tag identification data with a spreading sequence to produce a resultant output;
reflecting the RF signal from the RFID tag to the RFID reader as a spread spectrum modulated backscatter signal modulated with the resultant output and having a signal to noise ratio higher than a backscatter signal modulated without the spreading sequence;
reading the spread spectrum modulated backscatter signal at the RFID reader, the RFID reader having a first receive antenna; and
correlating the spread spectrum modulated backscatter signal against expected spreading sequences to identify the corresponding RFID tag that provided the spread spectrum modulated backscatter signal, even with the spread spectrum modulated backscatter signal being reflected at a power too low to be read by the RFID reader when absent the spreading sequence.

8. The method of claim 7, further comprising reading the spread spectrum modulated backscatter signal at a second antenna, and determining the location of the corresponding RFID tag based on the spread spectrum modulated backscatter signal.

9. The method of claim 7, further comprising generating the spreading sequence at the RFID tag.

10. The method of claim 7, further comprising generating the spreading sequence at the RFID reader and transmitting the spreading sequence with the RF signal.

11. The method of claim 7, further comprising transmitting the RF signal and reflecting the spread spectrum modulated backscatter signal as CDMA signals.

12. A CDMA communication system comprising an RFID reader in communication with a plurality of RFID tags having an integrated circuit and a memory unit, the memory unit storing tag data representing the RFID tag identification, each RFID tag having a spreading sequence associated with the tag, the RFID tags responding to an RF signal from the RFID reader with a CDMA signal including the tag data mixed with the spreading sequence, the RFID tag providing the CDMA signal having a signal to noise ratio higher that a corresponding backscatter signal without the spreading sequence, the RFID reader receiving and correlating the CDMA signal against expected spreading sequences to identify the corresponding RFID tag at a distance greater than for an RFID tag sending the corresponding backscatter signal without the spreading sequence.
